(19) United States
(12) Patent Application Publication
(10) Pub. No.: US 2012/0272062 A1
(43) Pub. Date: Oct. 25, 2012

(54) APPARATUS AND METHOD FOR CONTROLLING DEVICES USING PORTABLE TERMINAL IN DEVICE AUTOMATION SYSTEM

(75) Inventors: Joon-Hee LEE, Corona, CA (US); Kwon-Soo CHANG, Incheon (KR)

(73) Assignee: ICSN-KOREA, INC., Seoul (KR)

(21) Appl. No.: 13/090,717

(22) Filed: Apr. 20, 2011

(51) Int. Cl. H04L 9/32; G06F 15/16

(52) U.S. Cl. 713/170; 709/206

(57) ABSTRACT

A method is provided for controlling a device by a portable terminal in a device automation system. Upon detecting an execution request for a single remote control mode for remotely controlling a device, the portable terminal sends a single remote control mode execution request message for requesting to execute the single remote control mode, to the device. Upon receiving from the device a single remote control mode execution response message being responsive to the single remote control mode execution request message, the portable terminal switches an operation mode thereof to the single remote control mode. Upon receiving from the device a device data message including device data output by the device, the portable terminal outputs the device data. Upon detecting a remote control command to remotely control the device while outputting the device data, the portable terminal sends a remote control message including the remote control command to the device.

### BACKGROUND OF THE INVENTION

1. Field of the Invention

The present invention relates to an apparatus and method for controlling devices using a portable terminal in a device automation system.

2. Description of the Related Art

A device automation system refers to a system for automatically controlling devices in its area, and may include a home automation system as a typical example thereof. The home automation system performs a remote control function of controlling turning-on/off of home devices, such as home appliances, lighting devices, and audio devices, using a portable terminal, for example, a mobile phone; an automatic crime/disaster detection function of alarming gas leaks, fires, and theft; and a door phone function of notifying the situations of the front door or main gate.

Recently, with the remarkable development of computer and communication technologies, the home automation system has evolved to perform a variety of functions like the e-commerce and home banking functions over the Internet, in addition to the remote control function, the automatic crime/disaster detection function, and the door phone function.

Among home appliances, the TeleVision (TV) has evolved into various types of TVs, including smart TV, interactive TV using a set-top box (or Internet Protocol (IP) TV), cable TV, satellite TV, and Internet TV (or connected TV). The evolution of TV has caused an increase in complexity of User Interface (UI) of TV, and the continuous development of TV's functions has contributed to providing various applications. Various situations a user may experience while watching TV will now be described below.

First, in order to change a channel, a volume, or an option while watching TV, a user should manipulate a remote controller or step up to the TV to change them.

Second, if a user has a visitor while watching TV, the user should go and open the door after stopping watching TV, or should open the door by pushing a ‘door open’ button on a door phone.

Third, if a user wants to search the Internet while watching TV, the user should turn on the computer to search the Internet.

Fourth, if the room temperature is too high or low while a user watches TV, the user should go to the boiler room to adjust the temperature, or should go and manipulate the room thermostat.

Fifth, if the room is too bright or dark while a user watches TV, the user should go to the window to close or open the curtain.

As described above, a user may experience various situations while watching TV. In this case, despite the installation of the home automation system, the user may inconveniently manually control related devices to cope with the situations, which deteriorates efficiency of the home automation system. In other words, the conventional home automation system may not meet diverse needs of users, decreasing user satisfaction for the home automation system.

To reduce the inconvenience to users of the home automation system, a TV remote control program has been proposed, which may link the home automation system to mobile phones or smart phones. Even in this case, however, the smart phone merely replaces the conventional remote controller, failing to completely relieve the inconvenience to users.

### SUMMARY OF THE INVENTION

An aspect of exemplary embodiments of the present invention is to provide an apparatus and method for controlling devices using a touch interface of a portable terminal in a device automation system.

Another aspect of exemplary embodiments of the present invention is to provide an apparatus and method for controlling devices using a multiplex interface in a device automation system.

In accordance with one aspect of the present invention, there is provided a method for controlling a device by a portable terminal in a device automation system. The method includes, upon detecting an execution request for a single remote control mode for remotely controlling a device, sending a single remote control mode execution request message for requesting to execute the single remote control mode, to the device; upon receiving from the device a single remote control mode execution response message being responsive to the single remote control mode execution request message, switching an operation mode thereof to the single remote control mode; upon receiving from the device a device data message including device data output by the device, outputting the device data; and upon detecting a remote control command to remotely control the device while outputting the device data, sending a remote control message including the remote control command to the device.

In accordance with another aspect of the present invention, there is provided a method for performing an operation by a device in a device automation system. The method includes receiving from a portable terminal a single remote control mode execution request message for requesting to execute a single remote control mode for remotely controlling the device; sending a single remote control mode execution response message being responsive to the single remote control mode execution request message, to the portable terminal, and then switching an operation mode thereof to the single remote control mode; upon detecting device data to output, sending a device data message including the device data to the portable terminal; and upon receiving a remote control message including a remote control command to remotely control the device from the portable terminal while outputting the device data, performing an operation corresponding to the remote control command.

In accordance with further another aspect of the present invention, there is provided a method for controlling a device by a portable terminal in a device automation system. The method includes, upon detecting an execution request for a multiplex remote control mode for remotely controlling a first device and a second device, sending to the first device a multiplex remote control mode execution request message for requesting to execute the multiplex remote control mode; upon receiving from the first device a multiplex remote control mode execution response message being responsive to the multiplex remote control mode execution request message, sending a multiplex remote control mode execution confirm message to the first device; switching an operation mode thereof to the multiplex remote control mode after sending the multiplex remote control mode execution confirm message; upon receiving from the first device a first-device data message including first-device data output by the first device, outputting the first-device data; upon receiving an event data message including event data generated in the second device from the first device while outputting the first-device data, outputting the event data; and upon detecting a remote control command to remotely control the second device after outputting the event data, sending a remote control message including the remote control command to the second device through the first device.

In accordance with yet another aspect of the present invention, there is provided a method for performing an operation by a first device in a device automation system. The method includes receiving from a portable terminal a multiplex remote control mode execution request message for requesting to execute a multiplex remote control mode for remotely controlling the first device and a second device; sending the multiplex remote control mode execution request message to the second device; upon receiving a multiplex remote control mode execution response message from the second device, sending to the portable terminal the multiplex remote control mode execution response message being responsive to the multiplex remote control mode execution request message; switching an operation mode thereof to the multiplex remote control mode after receiving a multiplex remote control mode execution confirm message from the portable terminal; upon detecting first-device data to output, sending a first-device data message including the first-device data to the portable terminal; upon receiving an event data message including event data generated in the second device from the second device while outputting the first-device data, sending the event data message to the portable terminal; and upon receiving a remote control message including a remote control command to remotely control the second device from the portable terminal after outputting the event data, sending the remote control message to the second device.

In accordance with still another aspect of the present invention, there is provided a method for performing an operation by a second device in a device automation system. The method includes receiving from the first device a multiplex remote control mode execution request message for requesting to execute a multiplex remote control mode for remotely controlling a first device and the second device using a portable terminal; sending to the first device a multiplex remote control mode execution response message being responsive to the multiplex remote control mode execution request message; switching an operation mode thereof to the multiplex remote control mode after receiving a multiplex remote control mode execution confirm message from the first device; upon detecting occurrence of event data, sending an event data message including the event data to the first device; and upon receiving a remote control message including a remote control command to remotely control the second device from the first device while outputting the event data, performing an operation corresponding to the remote control command.

In accordance with still another aspect of the present invention, there is provided a portable terminal in a device automation system. The portable terminal includes a control unit, a wireless interface unit, and an output unit. If the control unit detects an execution request for a single remote control mode for remotely controlling a device, the wireless interface unit may send a single remote control mode execution request message for requesting to execute the single remote control mode, to the device. If the wireless interface unit receives from the device a single remote control mode execution response message being responsive to the single remote control mode execution request message, the control unit may switch an operation mode thereof to the single remote control mode. If the wireless interface unit receives from the device a device data message including device data output by the device, the output unit may output the device data. If the control unit detects a remote control command to remotely control the device while the output unit outputs the device data, the wireless interface unit may send a remote control message including the remote control command to the device.

In accordance with still another aspect of the present invention, there is provided a device in a device automation system. The device includes a control unit, a wireless interface unit, and an output unit. The wireless interface unit may receive from a portable terminal a single remote control mode execution request message for requesting to execute a single remote control mode for remotely controlling the device, and send a single remote control mode execution response message being responsive to the single remote control mode execution request message, to the portable terminal. The control unit may switch an operation mode of the device to the single remote control mode. If the control unit detects device data to output, the wireless interface unit may send a device data message including the device data to the portable terminal. If the wireless interface unit receives a remote control message including a remote control command to remotely control the device from the portable terminal while the output unit outputs the device data, the control unit may perform an operation corresponding to the remote control command.

In accordance with still another aspect of the present invention, there is provided a portable terminal in a device automation system. The portable terminal includes a control unit, a wireless interface unit, and an output unit. If the control unit detects an execution request for a multiplex remote control mode for remotely controlling a first device and a second device, the wireless interface unit may send to the first device a multiplex remote control mode execution request message for requesting to execute the multiplex remote control mode. Upon receiving from the first device a multiplex remote control mode execution response message being responsive to the multiplex remote control mode execution request message, the wireless interface unit may send a multiplex remote control mode execution confirm message to the first device. The control unit may switch an operation mode of the portable terminal to the multiplex remote control mode after the wireless interface unit sends the multiplex remote control mode execution confirm message. If the wireless interface unit receives from the first device a first-device data message including first-device data output by the first device, the output unit may output the first-device data. If the wireless interface unit receives an event data message including event data generated in the second device from the first device while the output unit outputs the first-device data, the output unit may outputs the event data. If the control unit detects a remote control command to remotely control the second device after the output unit outputs the event data, the wireless interface unit may send a remote control message including the remote control command to the second device through the first device.

In accordance with still another aspect of the present invention, there is provided a first device in a device automation system. The first device includes a control unit, a wireless interface unit, and an output unit. The wireless interface unit may receive from a portable terminal a multiplex remote control mode execution request message for requesting to execute a multiplex remote control mode for remotely controlling the first device and a second device, send the multiplex remote control mode execution request message to the second device, and upon receiving a multiplex remote control mode execution response message from the second device, send to the portable terminal the multiplex remote control mode execution response message being responsive to the multiplex remote control mode execution request message. The control unit may switch an operation mode of the first device to the multiplex remote control mode after the wireless interface unit receives a multiplex remote control mode execution confirm message from the portable terminal. If the control unit detects first-device data to output, the wireless interface unit may send a first-device data message including the first-device data to the portable terminal. If the wireless interface unit receives an event data message including event data generated in the second device from the second device while the output unit outputs the first-device data, the wireless interface unit may send the event data message to the portable terminal. If the wireless interface unit receives a remote control message including a remote control command to remotely control the second device from the portable terminal after the output unit outputs the event data, the wireless interface unit may send the remote control message to the second device.

In accordance with still another aspect of the present invention, there is provided a second device in a device automation system. The second device includes a control unit, a wireless interface unit, and an output unit. The wireless interface unit may receive from the first device a multiplex remote control mode execution request message for requesting to execute a multiplex remote control mode for remotely controlling a first device and the second device using a portable terminal, and send to the first device a multiplex remote control mode execution response message being responsive to the multiplex remote control mode execution request message. The control unit may switch an operation mode of the second device to the multiplex remote control mode after the wireless interface unit receives a multiplex remote control mode execution confirm message from the first device. If the control unit detects occurrence of event data, the wireless interface unit may send an event data message including the event data to the first device. If the wireless interface unit receives a remote control message including a remote control command to remotely control the second device from the first device while the output unit outputs the event data, the control unit may perform an operation corresponding to the remote control command.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is diagram schematically illustrating a configuration of a device automation system according to an embodiment of the present invention;

FIG. 2 is a diagram schematically illustrating an internal structure of the first device 111 in FIG. 1;

FIG. 3 is a diagram schematically illustrating an internal structure of the second device 113 in FIG. 1;

FIG. 4 is a diagram schematically illustrating an internal structure of the portable terminal 115 in FIG. 1;

FIGS. 5A and 5B are signal flow diagrams schematically illustrating a process of remotely controlling a device using a portable terminal in a device automation system according to an embodiment of the present invention;

FIG. 6 is a flowchart illustrating an operation process of the portable terminal 500 in FIGS. 5A and 5B;

FIG. 7 is a flowchart illustrating an operation process of the first device 550 in FIGS. 5A and 5B;

FIGS. 8A to 8C are signal flow diagrams schematically illustrating a process of remotely controlling a plurality of devices using a portable terminal in a device automation system according to an embodiment of the present invention;

FIG. 9 is a flowchart illustrating an operation process of the portable terminal 800 in FIGS. 8A to 8C;

FIGS. 10A and 10B are flowcharts illustrating an operation process of the first device 830 in FIGS. 8A to 8C; and

FIG. 11 is a flowchart illustrating an operation process of the second device 860 in FIGS. 8A to 8C.

Throughout the drawings, the same drawing reference numerals will be understood to refer to the same elements, features and structures.

### DETAILED DESCRIPTION OF EXEMPLARY EMBODIMENTS

Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention provides an apparatus and method for controlling devices using a touch interface of a portable terminal in a device automation system.

In addition, the present invention provides an apparatus and method for controlling devices using a multiplex interface in a device automation system.

For example, the device automation system used in embodiments of the present invention may be a home automation system, and the portable terminal used therein may be a mobile phone. The devices (e.g., a first device and a second device) constituting the device automation system may be a TeleVision (TV) and a door phone, respectively.

Wireless interfaces used in embodiments of the present invention, including a wireless interface between the devices constituting the device automation system and a wireless interface between the devices and the portable terminal, may be, for example, a Bluetooth interface, a Zigbee interface, and a WiFi interface, which are short-range wireless interfaces.

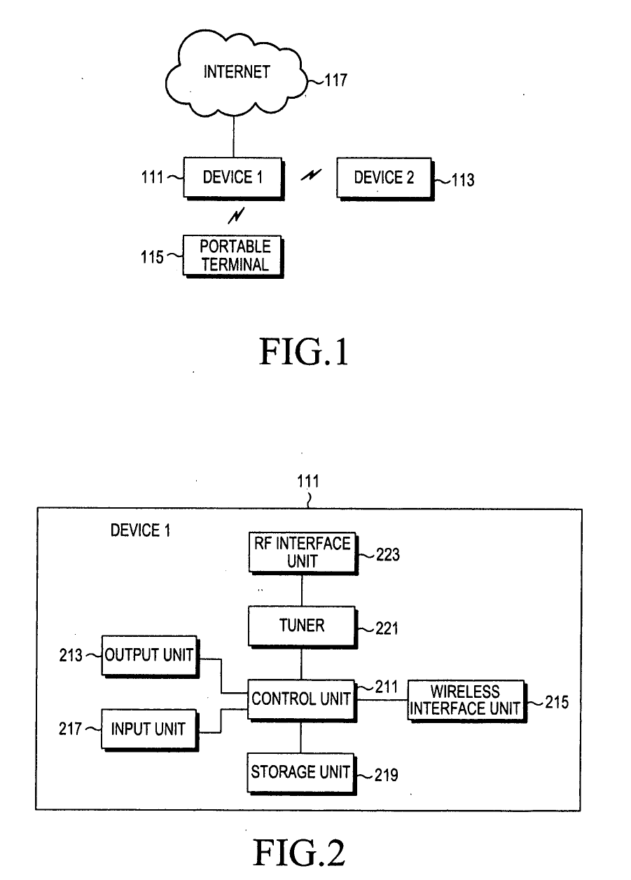

FIG. 1 schematically illustrates a configuration of a device automation system according to an embodiment of the present invention.

Referring to FIG. 1, the device automation system includes a plurality of devices, e.g., a first device 111 and a second device 113, and a portable terminal 115. The first device 111 is connected to the Internet 117, and may be, for example, a TV, which is one of smart TV, interactive TV with a set-top box (or Internet Protocol (IP) TV), cable TV, satellite TV, and Internet TV (or connected TV). The second device 113 may be a door phone, and the portable terminal 115 may be a mobile phone. The first device 111, the second device 113, and the portable terminal 115 may communicate with each other using their wireless interfaces.

The portable terminal 115 outputs all or part of the data output from the first device 111 or the second device 113 in real time. The data output from the first device 111 or the second device 113 may be image data, user menu data, etc. The amount of data output from each of the first device 111, the second device 113, and the portable terminal 115 may be determined according to the bandwidth provided by the wireless interface. If the amount of data output from the first device 111 needs a bandwidth exceeding the bandwidth provided by the wireless interface, only part of the data output from the first device 111 may be transmitted to the portable terminal 115. Thus, the portable terminal 115 outputs only part of the data output from the first device 111. For example, if the amount of image data and user menu data output from the first device 111 needs a bandwidth exceeding the bandwidth provided by the wireless interface, the first device 111 may transmit only the user menu data to the portable terminal 115. Thus, the portable terminal 115 may output only the user menu data.

Upon receiving a remote control command for the first device 111 or the second device 113, the portable terminal 115 sends the remote control command to the first device 111 or the second device 113 to control the first device 111 or the second device 113. An operation of remotely controlling the first device 111 or the second device 113 using the portable terminal 115 will be described herein below.

The configuration of the device automation system according to an embodiment of the present invention has been described so far with reference to FIG. 1. An internal structure of the first device 111 in FIG. 1 will now be described with reference to FIG. 2.

FIG. 2 schematically illustrates an internal structure of the first device 111 in FIG. 1.

Referring to FIG. 2, the first device 111 includes a control unit 211, an output unit 213, a wireless interface unit 215, an input unit 217, a storage unit 219, a tuner 221, and a Radio Frequency (RF) interface Unit 223.

The control unit 211 controls the overall operation of the first device 111, especially controls a single remote control mode operation with the portable terminal 115 and a multiplex remote control mode operation with the portable terminal 115 and the second device 113. The ‘single remote control mode’ as used herein may refer to a remote control mode used when the control unit 211 remotely controls one device using the portable terminal 115, while the ‘multiplex remote control mode’ may refer to a remote control mode used when the control unit 211 remotely controls two or more devices using the portable terminal 115.

The wireless interface unit 215, under control of the control unit 211, sends various messages to the portable terminal 115 and the second device 113, and receives various messages from the portable terminal 115 and the second device 113.

The output unit 213, under control of the control unit 211, outputs various messages and data, especially format-converts the data detected by the tuner 221 into first-device data (data for the first device) before outputting it.

The input unit 217, which may be realized with a keypad, receives various data under control of the control unit 211.

The storage unit 219 stores various data and programs required for an operation of the first device 111, and stores various data generated under control of the control unit 211.

The RF interface unit 223 performs a wireless communication operation of the first device 111 under control of the control unit 211. For that purpose, the RF interface unit 223 includes an RF transmission unit for frequency-up-converting and amplifying signals to be transmitted, and an RF reception unit for amplifying and frequency-down-converting received signals.

The tuner 221 detects only first-device data in an associated bandwidth from the signals RF-processed by the RF interface unit 223, and outputs the detected data to the control unit 211.

Although the control unit 211, the output unit 213, the wireless interface unit 215, the input unit 217, the storage unit 219, the tuner 221, and the RF interface unit 223 are realized as separate units in FIG. 2, they may be integrated in a single unit.

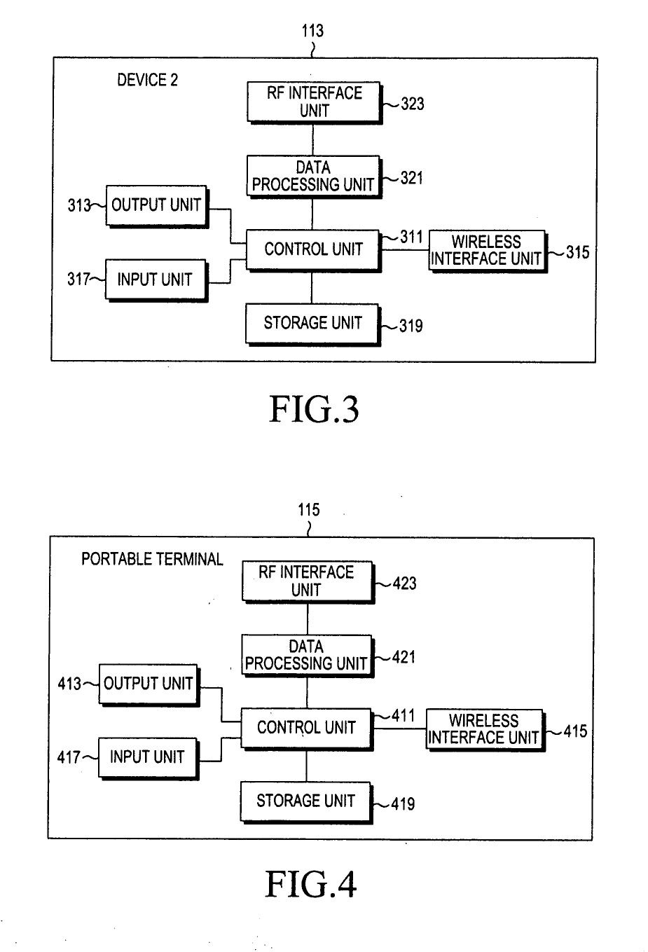

The internal structure of the first device 111 in FIG. 1 has been described so far with reference to FIG. 2. An internal structure of the second device 113 in FIG. 1 will now be described with reference to FIG. 3.

FIG. 3 schematically illustrates an internal structure of the second device 113 in FIG. 1.

Referring to FIG. 3, the second device 113 includes a control unit 311, an output unit 313, a wireless interface unit 315, an input unit 317, a storage unit 319, a data processing unit 321, and an RF interface unit 323.

The control unit 311 controls the overall operation of the second device 113, especially controls a single remote control mode operation with the portable terminal 115 and a multiplex remote control mode operation with the portable terminal 115 and the first device 111.

The wireless interface unit 315, under control of the control unit 311, sends various messages to the portable terminal 115 and the first device 111, and receives various messages from the portable terminal 115 and the first device 111.

The output unit 313 outputs various messages and data under control of the control unit 311.

The input unit 317, which may be realized with a keypad, receives various data under control of the control unit 311.

The storage unit 319 stores various data and programs needed for an operation of the second device 113, and stores various data generated under control of the control unit 311.

The RF interface unit 323 performs a wireless communication operation of the second device 113 under control of the control unit 311. For that purpose, the RF interface unit 323 includes an RF transmission unit for frequency-up-converting and amplifying signals to be transmitted, and an RF reception unit for amplifying and frequency-down-converting received signals.

The data processing unit 321 receives and processes the signals RF-processed by the RF interface unit 323, and outputs the processed data to the control unit 311.

Although the control unit 311, the output unit 313, the wireless interface unit 315, the input unit 317, the storage unit 319, the data processing unit 321, and the RF interface unit 323 are realized as separate units in FIG. 3, they may be integrated in a single unit.

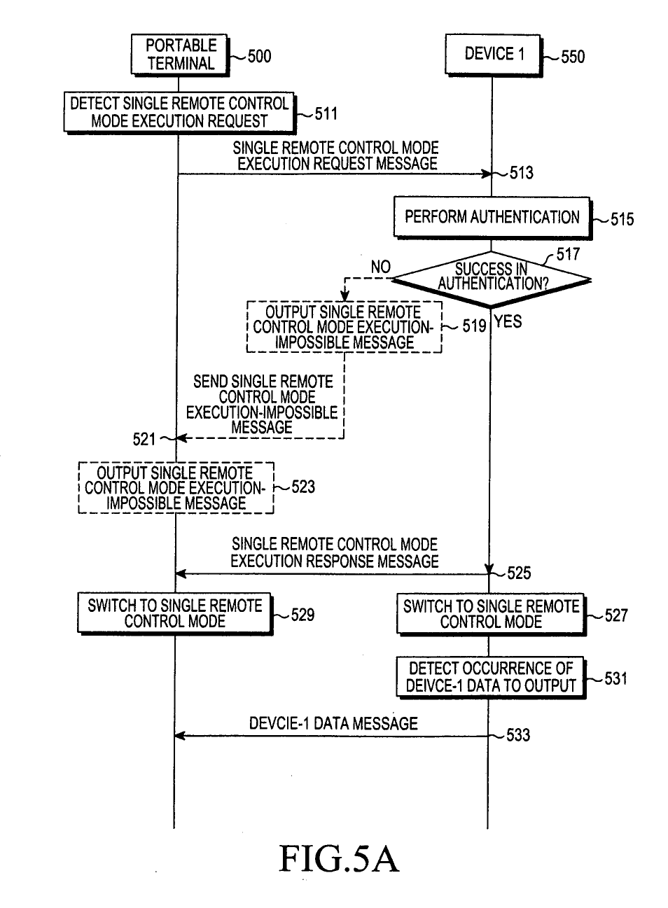

The internal structure of the second device 113 has been described so far with reference to FIG. 3. An internal structure of the portable terminal 115 in FIG. 1 will now be described in detail with reference to FIG. 4.

FIG. 4 schematically illustrates an internal structure of the portable terminal 115 in FIG. 1.

Referring to FIG. 4, the portable terminal 115 includes a control unit 411, an output unit 413, a wireless interface unit 415, an input unit 417, a storage unit 419, a data processing unit 421, and an RF interface unit 423.

The control unit 411 controls the overall operation of the portable terminal 115, especially controls a single remote control mode operation with the first device 111 and a multiplex remote control mode operation with the first device 111 and the second device 113.

The wireless interface unit 415, under control of the control unit 411, sends various messages to the first device 111 and the second device 113, and receives various messages from the device 111 and the second device 113.

The output unit 413 outputs various data and messages under control of the control unit 411.

The input unit 417, which may be realized with a touch panel, receives various data under control of the control unit 411. When realized with a touch panel, the input unit 417 is provided with a user interface in the form of a touch interface, increasing user convenience of the device automation system. Particularly, if the first device 111 is a large-size device like a TV, because realizing its input unit with a touch panel is almost impossible in terms of the technology and the cost, a user interface of the first device 111 may be realized with a touch interface using the touch panel mounted in the portable terminal 115.

The storage unit 419 stores various data and programs necessary for an operation of the portable terminal 115, and stores various data generated under control of the control unit 411.

The RF interface unit 423 performs a wireless communication operation of the portable terminal 115 under control of the control unit 411. For that purpose, the RF interface unit 423 includes an RF transmission unit for frequency-up-converting and amplifying signals to be transmitted, and an RF reception unit for amplifying and frequency-down-converting received signals.

The data processing unit 421 receives and processes the signals RF-processed by the RF interface unit 423, and outputs the processed data to the control unit 411.

Although the control unit 411, the output unit 413, the wireless interface unit 415, the input unit 417, the storage unit 419, the data processing unit 421, and the RF interface unit 423 are realized as separate units in FIG. 4, they may be integrated in a single unit.

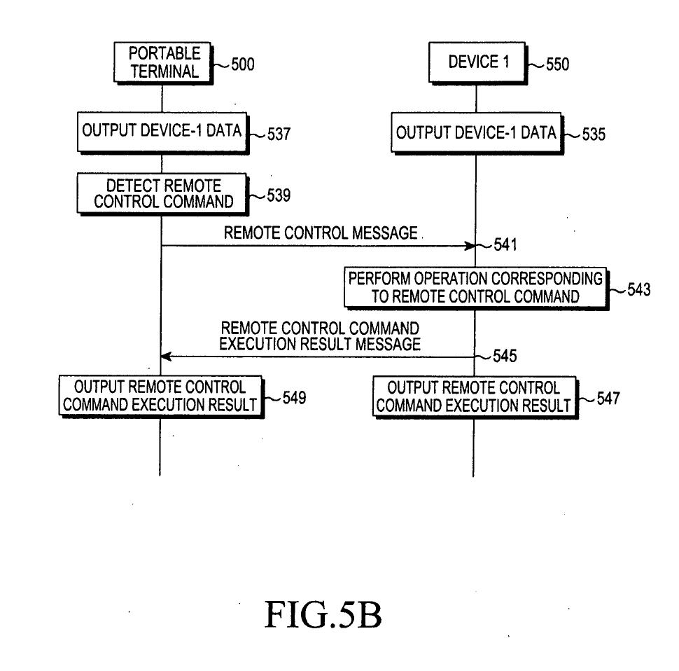

The internal structure of the portable terminal 115 in FIG. 1 has been described so far with reference to FIG. 4. A process of remotely controlling a device using a portable terminal in a device automation system according to an embodiment of the present invention will now be described with reference to FIGS. 5A and 5B.

FIGS. 5A and 5B schematically illustrate a process of remotely controlling a device using a portable terminal in a device automation system according to an embodiment of the present invention.

Before a description of FIGS. 5A and 5B, it will be assumed that among the devices constituting the device automation system, a device that is remotely controlled by a portable terminal 500 is, for example, a first device 550. Although the portable terminal 500 remotely controls the first device 550 in FIGS. 5A and 5B by way of example, the portable terminal 500 may remotely control a second device as well in a similar way.

Referring to FIGS. 5A and 5B, upon detecting a single remote control mode execution request for requesting to execute or run a single remote control mode for remotely controlling the first device 550 in step 511, the portable terminal 500 sends a single remote control mode execution request message for requesting to execute the single remote control mode to the first device 550 in step 513. The single remote control mode execution request message includes an Identifier (ID) of the portable terminal 500, an ID of the first device 550, an Authentication Key (AK), and a single remote control mode execution command. The AK is assigned in common to devices constituting the device automation system and the portable terminal 500 in advance. The AK may be generated in various different ways, and a detailed description thereof will be omitted.

In step 515, the first device 550 performs an authentication operation on the portable terminal 500 according to a predetermined authentication method using the AK included in the single remote control mode execution request message. The authentication method may be realized in various different ways, and a detailed description thereof will be omitted.

In step 517, the first device 550 checks if the authentication on the portable terminal 500 is successful. If the authentication on the portable terminal 500 is failed, the first device 550 outputs a single remote control mode execution-impossible message indicating the impossibility of executing the single remote control mode using the portable terminal 500 in step 519, and sends the single remote control mode execution-impossible message to the portable terminal 500 in step 521. Upon receiving the single remote control mode execution-impossible message from the first device 550, the portable terminal 500 outputs a single remote control mode execution-impossible message after recognizing or detecting the impossibility of remotely controlling the first device 550, in step 523.

However, if the authentication on the portable terminal 500 is successful, the first device 550 sends a single remote control mode execution response message indicating the possibility of executing the single remote control mode and being responsive to the single remote control mode execution request message, to the portable terminal 500 in step 525, and switches its operation mode to the single remote control mode in step 527. Upon receiving the single remote control mode execution response message from the first device 550, the portable terminal 500 switches its operation mode to the single remote control mode after detecting the possibility of remotely controlling the first device 550, in step 529.

If the first device 550 detects occurrence of first-device data to output in step 531, the first device 550 sends a first-device data message including the first-device data to the portable terminal 500 in step 533, and outputs the detected first-device data in step 535. Upon receiving the first-device data message from the first device 550, the portable terminal 500 detects and outputs the first-device data included in the first-device data message in step 537. As a result, the first device 550 and the portable terminal 500 may output the same first-device data in real time, so a user of the portable terminal 500 may view the same first-device data not only on the first device 550 but also on the portable terminal 500.

If the portable terminal 500 detects a remote control command for remotely controlling the first device 550 while outputting the first-device data in step 539, the portable terminal 500 sends a remote control message including the remote control command to the first device 550 in step 541. The remote control command may include various commands to remotely control an operation of the first device 550, like a command to change a channel of the first device 550 and a command to change a volume of the first device 550.

Upon receiving the remote control message from the portable terminal 500, the first device 550 performs an operation corresponding to the remote control command included in the remote control message in step 543. After performing the operation corresponding to the remote control command, the first device 550 sends a remote control command execution result message including the operation execution result or the remote control command execution result, to the portable terminal 500 in step 545. Subsequently, the first device 550 outputs the remote control command execution result in step 547.

Upon receiving the remote control command execution result message from the first device 550, the portable terminal 500 detects and outputs the remote control command execution result included in the remote control command execution result message in step 549.

Although the portable terminal 500 detects the single remote control mode execution request directly from its user in FIGS. 5A and 5B, the portable terminal 500 may detect the single remote control mode execution request by receiving a single remote control mode execution request message from the first device 550. In this case, the portable terminal 500 may perform an authentication operation on the first device 550.

Although in FIGS. 5A and 5B, the single remote control mode execution response message is used only as a message indicating the possibility of executing the single remote control mode and a separate message indicating the impossibility of executing the single remote control mode, i.e., the single remote control mode execution-impossible message, is used by way of example, the single remote control mode execution response message may be configured to include a separate value indicating the possibility of executing the single remote control mode, or indicating the impossibility of executing the single remote control mode.

Although in FIGS. 5A and 5B, after the portable terminal 500 sent a single remote control mode execution request message, the first device 550 performs an authentication operation on the portable terminal 500 in response to the request, by way of example, the portable terminal 500 and the first device 550 may mutually perform an authentication operation in advance. The pre-authentication operation between the portable terminal 500 and the first device 550 may be performed in an initial setup procedure of the portable terminal 500 and the first device 550, or may be performed before the portable terminal 500 detects a single remote control mode execution request after performing the initial setup procedure.

If the device automation system remotely controls devices using a portable terminal as described with reference to FIGS. 5A and 5B, the portable terminal 500 may output data for the first device 550, such as user menu data, as it is, allowing its user to control the first device 550 using a touch interface of the portable terminal 500. Therefore, even though the first device 550 provides no touch interface, the user may conveniently control the first device 550 using the touch interface of the portable terminal 500, leading to the improvement of user convenience for the device automation system. In addition, the first device 550 does not require a touch panel for the touch interface, contributing to an increase in the cost efficiency.

In the device automation system described with reference to FIGS. 5A and 5B, the portable terminal 500 receives data from the first device 550 as it is, and outputs the same data, instead of controlling the first device 550 by running a specific application, thereby avoiding a load of the portable terminal 500, such as processing an application of the portable terminal 500.

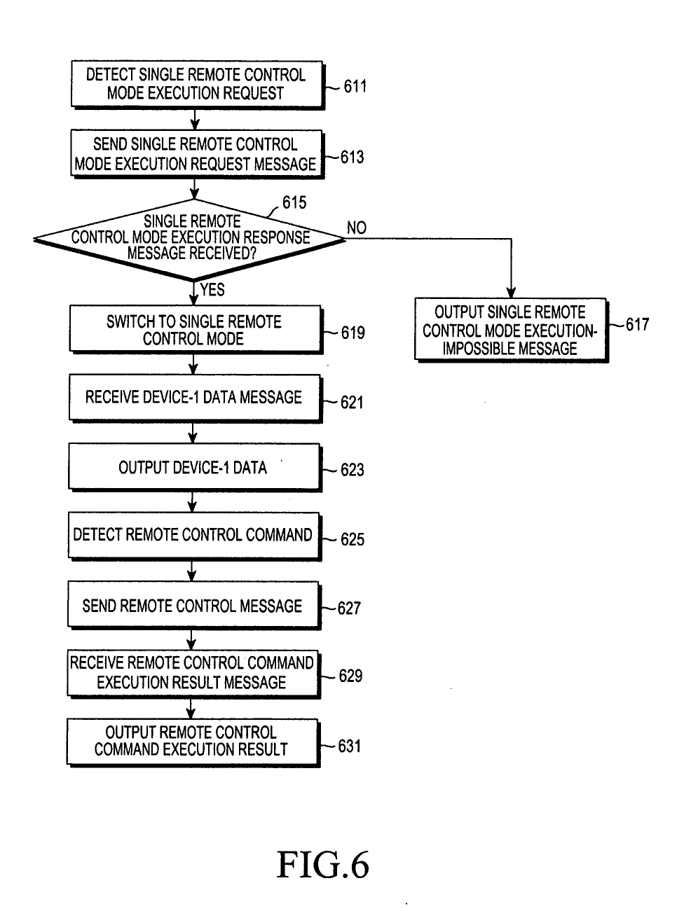

The process of remotely controlling a device using a portable terminal in a device automation system according to an embodiment of the present invention has been described so far with reference to FIGS. 5A and 5B. An operation process of the portable terminal 500 in FIGS. 5A and 5B will now be described with reference to FIG. 6.

FIG. illustrates an operation process of the portable terminal 500 in FIGS. 5A and 5B.

Referring to FIG. 6, upon detecting a single remote control mode execution request for requesting to execute or run a single remote control mode for remotely controlling the first device 550 in step 611, the portable terminal 500 sends a single remote control mode execution request message for requesting to execute the single remote control mode to the first device 550 in step 613. The single remote control mode execution request message includes an ID of the portable terminal 500, an ID of the first device 550, an AK, and a single remote control mode execution command. The AK is assigned in common to devices constituting the device automation system and the portable terminal 500 in advance. The AK may be generated in various different ways, and a detailed description thereof will be omitted.

In step 615, the portable terminal 500 checks if a single remote control mode execution response message is received from the first device 550. If no single remote control mode execution response message is received from the first device 550, or if a single remote control mode execution-impossible message is received from the first device 550, the portable terminal 500 outputs a single remote control mode execution-impossible message after detecting the impossibility of remotely controlling the first device 550, in step 617.

On the other hand, if a single remote control mode execution response message is received from the first device 550 in step 615, the portable terminal 500 switches its operation mode to the single remote control mode in step 619, and receives a first-device data message including first-device data from the first device 550 in step 621.

In step 623, the portable terminal 500 detects and outputs the first-device data included in the first-device data message. From now on, the first device 550 and the portable terminal 500 output the same first-device data in real time, so a user of the portable terminal 500 may view the same data not only on the first device 550 but also on the portable terminal 500.

Upon detecting a remote control command to remotely control the first device 550 in step 625 while outputting the first-device data, the portable terminal 500 proceeds to step 627. The remote control command may include various commands to remotely control an operation of the first device 550, like a command to change a channel of the first device 550 and a command to change a volume of the first device 550. In step 627, the portable terminal 500 sends a remote control message including the remote control command to the first device 550.

In step 629, the portable terminal 500 receives from the first device 550 a remote control command execution result message including the results of executing an operation corresponding to the remote control command, i.e., including the remote control command execution result. In step 631, the portable terminal 500 outputs the remote control command execution result included in the remote control command execution result message.

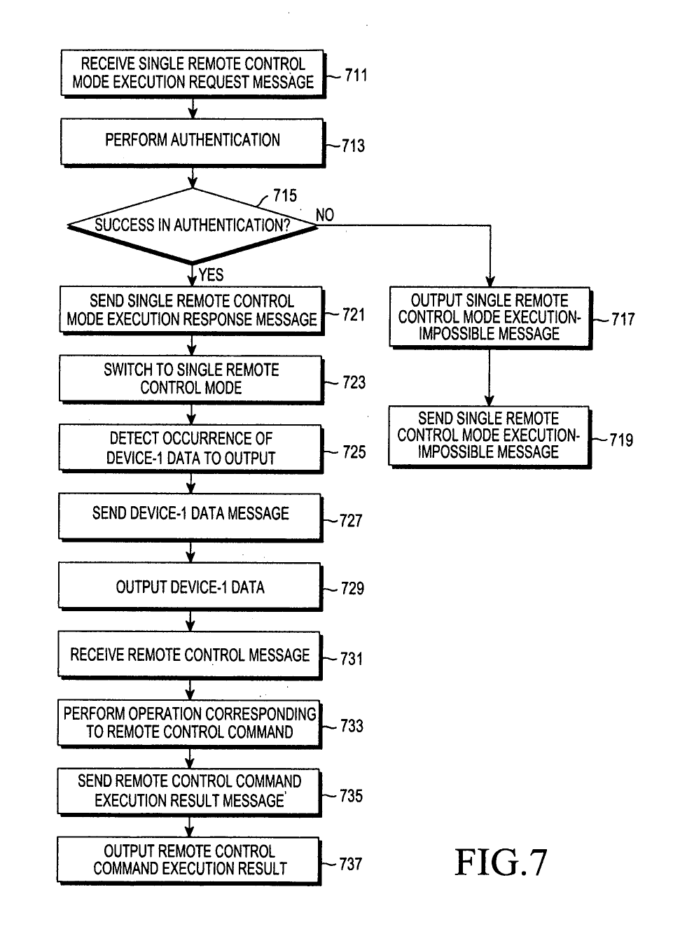

An operation process of the first device 550 in FIGS. 5A and 5B will now be described with reference to FIG. 7.

FIG. 7 illustrates an operation process of the first device 550 in FIGS. 5A and 5B.

Referring to FIG. 7, upon receiving from a portable terminal 500 a single remote control mode execution request message for requesting the first device 550 to execute the single remote control mode in step 711, the first device 550 proceeds to step 713. The single remote control mode execution request message includes an ID of the portable terminal 500, an ID of the first device 550, an AK, and a single remote control mode execution command. The AK is assigned in common to devices constituting the device automation system and the portable terminal 500 in advance. The AK may be generated in various different ways, and a detailed description thereof will be omitted.

In step 713, the first device 550 performs an authentication operation on the portable terminal 500 according to a predetermined authentication method using the AK included in the single remote control mode execution request message. The authentication method may be realized in various different ways, and a detailed description thereof will be omitted. In step 715, the first device 550 checks if the authentication on the portable terminal 500 is successful. Upon failure in the authentication, the first device 550 outputs a single remote control mode execution-impossible message indicating the impossibility of executing the single remote control mode using the portable terminal 500, in step 717, and sends the single remote control mode execution-impossible message to the portable terminal 500 in step 719.

Upon success in the authentication in step 715, the first device 550 sends a single remote control mode execution response message indicating the possibility of executing the single remote control mode and being responsive to the single remote control mode execution request message, to the portable terminal 500 in step 721, and switches its operation mode to the single remote control mode in step 723.

Upon detecting occurrence of first-device data to output in step 725, the first device 550 sends a first-device data message including the first-device data to the portable terminal 500 in step 727, and outputs the detected first-device data in step 729. From now on, the first device 550 and the portable terminal 500 outputs the same first-device data in real time, so a user of the portable terminal 500 may view the same data not only on the first device 550 but also on the portable terminal 500.

In step 731, the first device 550 receives from the portable terminal 500 a remote control message including a remote control command to remotely control the first device 550. The remote control command may include various commands to remotely control an operation of the first device 550, like a command to change a channel of the first device 550 and a command to change a volume of the first device 550. In step 733, the first device 550 performs an operation corresponding to the remote control command included in the remote control message.

In step 735, the first device 550 sends to the portable terminal 500 a remote control command execution result message including the result of executing the operation corresponding to the remote control command, i.e., including the remote control command execution result. In step 737, the first device 550 outputs the remote control command execution result.

It is assumed in FIG. 7 that in FIGS. 5A and 5B, after the portable terminal 500 sends a single remote control mode execution request message, the first device 550 performs an authentication operation on the portable terminal 500 in response to the request. Therefore, if the portable terminal 500 and the first device 550 perform an authentication operation in advance in FIGS. 5A and 5B, the operation process of the first device 550 in FIG. 7 may be modified according thereto.

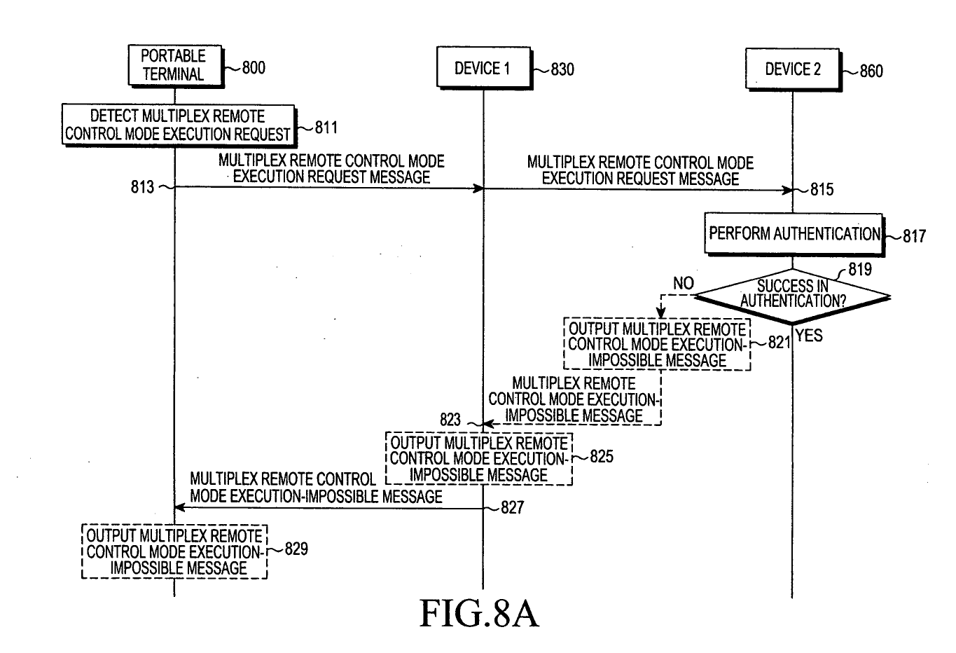

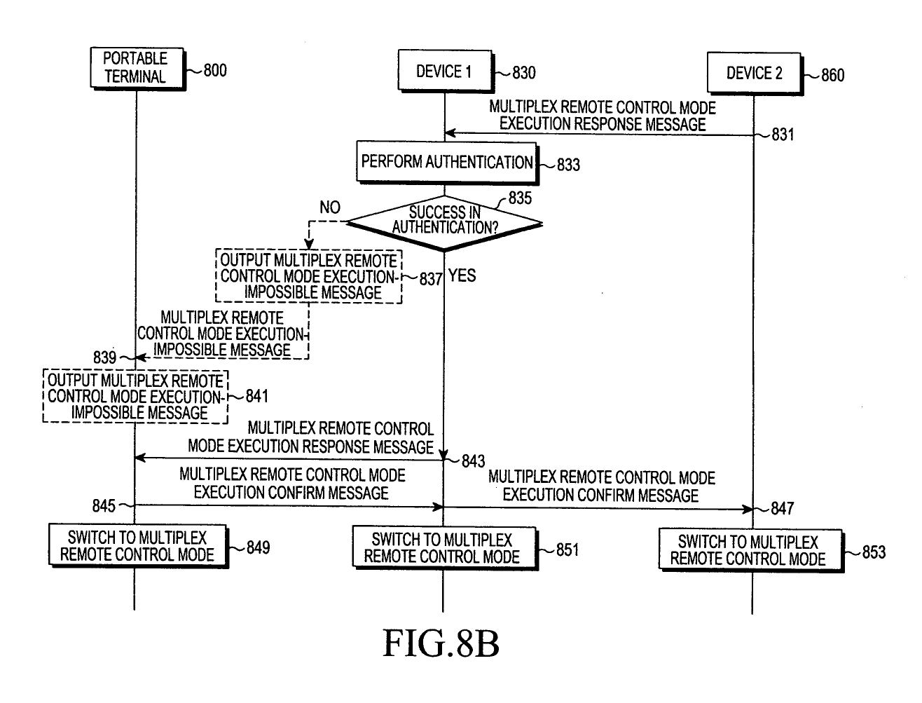

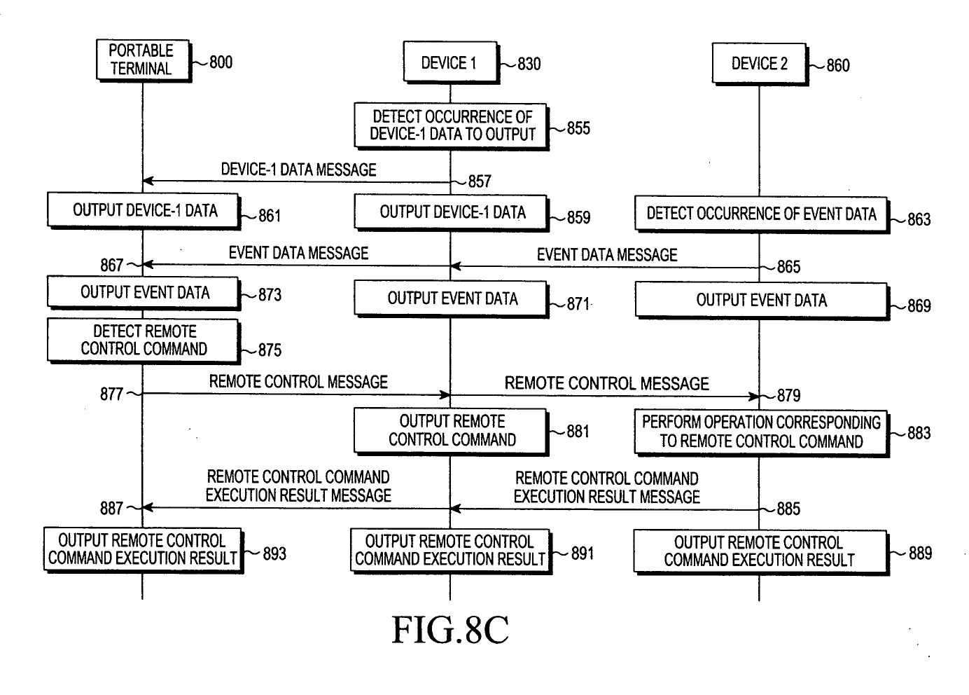

The operation process of the first device 550 in FIGS. 5A and 5B has been descried so far with reference to FIG. 7. A process of remotely controlling a plurality of devices using a portable terminal in a device automation system according to an embodiment of the present invention will now be described with reference to FIGS. 8A to 8C.

FIGS. 8A to 8C schematically illustrate a process of remotely controlling a plurality of devices using a portable terminal in a device automation system according to an embodiment of the present invention.

Before a description of FIGS. 8A to 8C, it will be assumed that among the devices constituting the device automation system, devices that are remotely controlled by a portable terminal 800 are, for example, a first device 830 and a second device 860.

Referring to FIGS. 8A to 8C, upon detecting a multiplex remote control mode execution request for requesting to execute or run a multiplex remote control mode for remotely controlling the first device 830 and the second device 860 in step 811, the portable terminal 800 sends a multiplex remote control mode execution request message for requesting to execute the multiplex remote control mode, to the first device 830 in step 813. The multiplex remote control mode execution request message includes an ID of the portable terminal 800, an ID of the first device 830, an ID of the second device 860, an AK, and a multiplex remote control mode execution command. The AK is assigned in common to devices constituting the device automation system and the portable terminal 800 in advance. The AK may be generated in various different ways, and a detailed description thereof will be omitted.

Upon receiving the multiplex remote control mode execution request message from the portable terminal 800, the first device 830 sends the multiplex remote control mode execution request message to the second device 860 in step 815. Upon receiving the multiplex remote control mode execution request message, the second device 860 performs an authentication operation on the portable terminal 800 and the first device 830 according to a predetermined authentication method using the AK included in the multiplex remote control mode execution request message in step 817. The authentication method may be realized in various different ways, and a detailed description thereof will be omitted.

In step 819, the second device 860 checks if the authentication on the portable terminal 800 and the first device 830 is successful. Upon failure in the authentication on the portable terminal 800 and the first device 830, the second device 860 outputs a multiplex remote control mode execution-impossible message indicating the impossibility of executing the multiplex remote control mode using the portable terminal 800, in step 821, and sends the multiplex remote control mode execution-impossible message to the first device 830 in step 823. Upon receiving the multiplex remote control mode execution-impossible message from the second device 860, the first device 830 outputs the multiplex remote control mode execution-impossible message in step 825, and sends the multiplex remote control mode execution-impossible message to the portable terminal 800 in step 827. Upon receiving the multiplex remote control mode execution-impossible message from the first device 830, the portable terminal 800 outputs the multiplex remote control mode execution-impossible message in step 829.

However, upon success in the authentication on the portable terminal 800 and the first device 830 in step 819, the second device 860 sends a multiplex remote control mode execution response message indicating the possibility of executing the multiplex remote control mode and being responsive to the multiplex remote control mode execution request message, to the first device 830 in step 831. Upon receiving the multiplex remote control mode execution response message from the second device 860, the first device 830 performs an authentication operation on the portable terminal 800 according to a predetermined authentication method using the AK included in the multiplex remote control mode execution response message in step 833. The authentication method may be realized in various different ways, and a detailed description thereof will be omitted.

In step 835, the first device 830 checks if the authentication on the portable terminal 800 is successful. Upon failure in the authentication on the portable terminal 800, the first device 830 outputs a multiplex remote control mode execution-impossible message indicating the impossibility of executing the multiplex remote control mode using the portable terminal 800, in step 837, and sends the multiplex remote control mode execution-impossible message to the portable terminal 800 in step 839. Upon receiving the multiplex remote control mode execution-impossible message from the first device 830, the portable terminal 800 outputs the multiplex remote control mode execution-impossible message in step 841.

However, upon success in the authentication in step 835, the first device 830 sends a multiplex remote control mode execution response message indicating the possibility of executing the multiplex remote control mode and being responsive to the multiplex remote control mode execution request message, to the portable terminal 800 in step 843.

Upon receiving the multiplex remote control mode execution response message from the first device 830, the portable terminal 800 sends a multiplex remote control mode execution confirm message to the first device 830 in step 845. Upon receiving the multiplex remote control mode execution confirm message from the portable terminal 800, the first device 830 sends the multiplex remote control mode execution confirm message to the second device 860 in step 847.

After sending the multiplex remote control mode execution confirm message, the portable terminal 800 and the first device 830 switch their operation modes to the multiplex remote control mode in steps 849 and 851, respectively, and upon receiving the multiplex remote control mode execution confirm message, the second device 860 also switches its operation mode to the multiplex remote control mode in step 853.

Upon detecting occurrence of first-device data to output in step 855, the first device 830 sends a first-device data message including the first-device data to the portable terminal 800 in step 857, and outputs the detected first-device data in step 859. Upon receiving the first-device data message from the first device 830, the portable terminal 800 detects and outputs the first-device data included in the first-device data message in step 861. Thus, the first device 830 and the portable terminal 800 output the same first-device data in real time, so a user of the portable terminal 800 may view the same data not only on the first device 830 but also on the portable terminal 800.

Upon detecting occurrence of event data for remote control in step 863, the second device 860 sends an event data message including the event data to the first device 830 in step 865. For example, the event data may be generated when a Bell button on the second device 860 is pushed. The first device 830 sends the event data message received from the second device 860 to the portable terminal 800 in step 867. All of the second device 860 having sent the event data message to the first device 830, the first device 830 having received the event data message from the second device 860, and the portable terminal 800 having received the event data message from the first device 830, output the event data in steps 869, 871 and 873, respectively.

Upon detecting a remote control command to remotely control the second device 860 in step 875 after outputting the event data, the portable terminal 800 sends a remote control message including the remote control command to the second device 860 through the first device 830 in steps 877 and 879. The remote control command may include various commands to remotely control an operation of the second device 860, like a command to release a lock of the second device 860. Upon receiving the remote control message from the portable terminal 800, the first device 830 outputs the remote control command included in the remote control message in step 881.

Upon receiving the remote control message from the first device 830, the second device 860 performs an operation corresponding to the remote control command included in the remote control message in step 883. After performing the operation corresponding to the remote control command, the second device 860 sends a remote control command execution result message including the operation execution result, or the result of executing the remote control command, to the portable terminal 800 through the first device 830 in steps 885 and 887.

The second device 860 having sent the remote control command execution result message, the first device 830 having received the remote control command execution result message from the second device 860, and the portable terminal 800 having received the remote control command execution result message from the first device 830, output the remote control command execution result in steps 889, 891 and 893, respectively.

In FIGS. 8A to 8C, after the portable terminal 800 sent a multiplex remote control mode execution request message, the second device 860 performs an authentication operation on the portable terminal 800 and the first device 830 in response to the request, and after receiving a multiplex remote control mode execution response message from the second device 860, the first device 830 performs an authentication operation on the second device 860. In the alternative, however, the portable terminal 800, the first device 830 and the second device 860 may perform an authentication operation in advance. The pre-authentication operation among the portable terminal 800, the first device 830 and the second device 860 may be performed in an initial setup procedure of the portable terminal 800, the first device 830 and the second device 860, or may be performed before the portable terminal 800 detects a multiplex remote control mode execution request after performing the initial setup procedure.

Although the portable terminal 800 detects the multiplex remote control mode execution request directly from its user in FIGS. 8A to 8C, the portable terminal 800 may detect the multiplex remote control mode execution request by receiving a multiplex remote control mode execution request message from the first device 830.

Although in FIGS. 8A to 8C, the multiplex remote control mode execution response message is used only as a message indicating the possibility of executing the multiplex remote control mode and a separate message indicating the impossibility of executing the multiplex remote control mode, i.e., the multiplex remote control mode execution-impossible message, is used by way of example, the multiplex remote control mode execution response message may be configured to include a separate value indicating the possibility of executing the multiplex remote control mode, or indicating the impossibility of executing the multiplex remote control mode.

If the device automation system remotely controls devices using a portable terminal as described with reference to FIGS. 8A to 8C, the portable terminal 800 may output data for the first device 830 and the second device 860, such as user menu data, as it is, allowing its user to control the first device 830 and the second device 860 using a touch interface of the portable terminal 800. Therefore, even though the first device 830 and the second device 860 provide no touch interface, the user may conveniently control the first device 830 and the second device 860 using the touch interface of the portable terminal 800, leading to the improvement of user convenience in controlling the first device 830 and the second device 860. As a result, the user convenience for the device automation system may be improved. In addition, the first device 830 and the second device 860 do not require a touch panel for the touch interface, contributing to an increase in the cost efficiency.

In the device automation system described with reference to FIGS. 8A to 8C, the portable terminal 800 receives data from the first device 830 and the second device 860 as it is, and outputs the same data, instead of controlling the first device 830 and the second device 860 by running a specific application, thereby avoiding a load of the portable terminal 800, such as processing an application of the portable terminal 800.

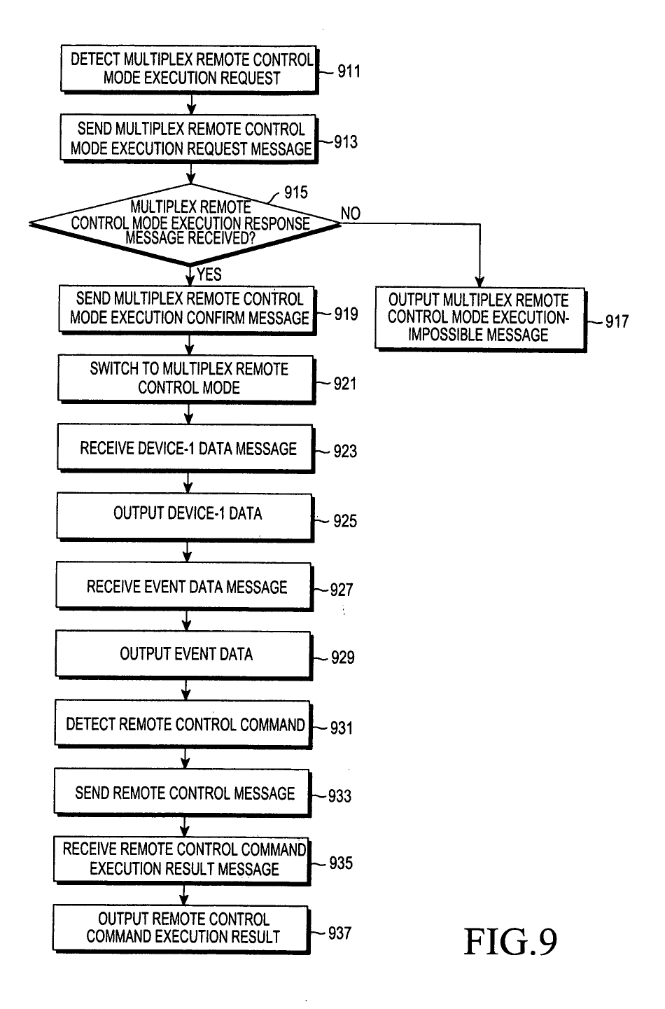

The process of remotely controlling a plurality of devices using a portable terminal in a device automation system according to an embodiment of the present invention has been described so far with reference to FIGS. 8A to 8C. An operation process of the portable terminal 800 in FIGS. 8A to 8C will now be described with reference to FIG. 9.

FIG. 9 illustrates an operation process of the portable terminal 800 in FIGS. 8A to 8C.

Referring to FIG. 9, upon detecting a multiplex remote control mode execution request for requesting to execute or run a multiplex remote control mode for remotely controlling the first device 830 and the second device 860 in step 911, the portable terminal 800 sends a multiplex remote control mode execution request message for requesting to execute the multiplex remote control mode to the first device 830 in step 913. The multiplex remote control mode execution request message includes an ID of the portable terminal 800, an ID of the first device 830, an ID of the second device 860, an AK, and a multiplex remote control mode execution command. The AK is assigned in common to devices constituting the device automation system and the portable terminal 800 in advance. The AK may be generated in various different ways, and a detailed description thereof will be omitted.

In step 915, the portable terminal 800 checks if a multiplex remote control mode execution response message is received from the first device 830. If no multiplex remote control mode execution response message is received from the first device 830, or if a multiplex remote control mode execution-impossible message is received from the first device 830, the portable terminal 800 outputs the multiplex remote control mode execution-impossible message in step 917.

On the other hand, if a multiplex remote control mode execution response message is received from the first device 830, the portable terminal 800 sends a multiplex remote control mode execution confirm message to the first device 830 in step 919 because it has received the multiplex remote control mode execution response message from the first device 830. In step 921, the portable terminal 800 switches its operation mode to the multiplex remote control mode. In step 923, the portable terminal 800 receives a first-device data message including first-device data from the first device 830. In step 925, the portable terminal 800 detects and outputs the first-device data included in the first-device data message.

In step 927, the portable terminal 800 receives an event data message from the first device 830. For example, the event data may be generated when a Bell button on the second device 860 is pushed. In step 929, the portable terminal 800 detects and outputs the event data included in the event data message. Upon detecting a remote control command to remotely control the second device 860 in step 931 after outputting the event data, the portable terminal 800 sends a remote control message including the remote control command to the first device 830 in step 933. In step 935, the portable terminal 800 receives from the first device 830 a remote control command execution result message including the result of executing an operation corresponding to the remote control command, i.e., including the remote control command execution result. In step 937, the portable terminal 800 detects and outputs the remote control command execution result included in the remote control command execution result message.

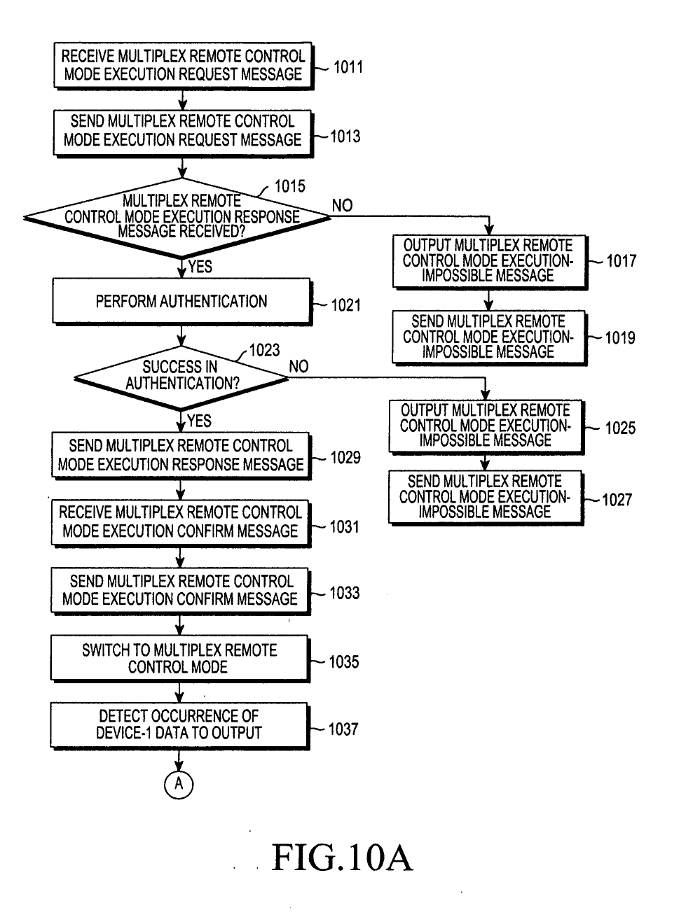

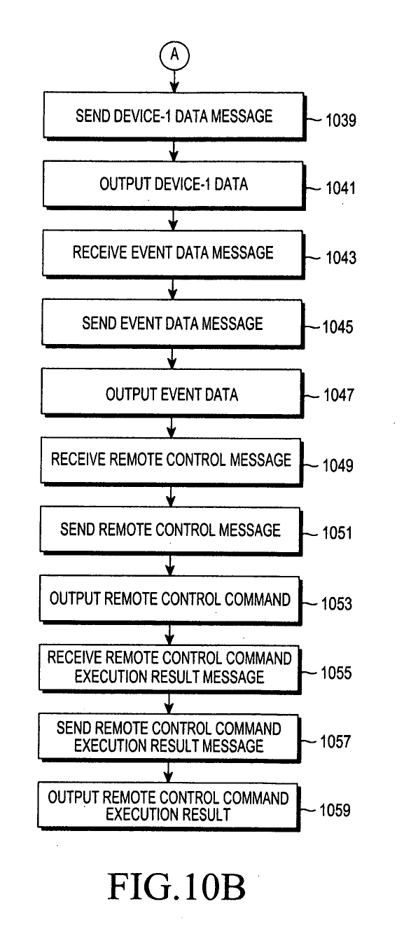

The operation process of the portable terminal 800 in FIGS. 8A to 8C has been described with reference to FIG. 9. An operation process of the first device 830 in FIGS. 8A to 8C will now be described with reference to FIGS. 10A and 10B.

FIGS. 10A and 10B illustrate an operation process of the first device 830 in FIGS. 8A to 8C.

Referring to FIGS. 10A and 10B, the first device 830 receives a multiplex remote control mode execution request message for requesting to execute or run a multiplex remote control mode for remotely controlling the first device 830 and the second device 860, from the portable terminal 800 in step 1011. The multiplex remote control mode execution request message includes an ID of the portable terminal 800, an ID of the first device 830, an ID of the second device 860, an AK, and a multiplex remote control mode execution command. The AK is assigned in common to devices constituting the device automation system and the portable terminal 800 in advance. The AK may be generated in various different ways, and a detailed description thereof will be omitted.

In step 1013, the first device 830 sends the multiplex remote control mode execution request message to the second device 860. In step 1015, the first device 830 checks if a multiplex remote control mode execution response message is received from the second device 860. If no multiplex remote control mode execution response message is received from the second device 860, or if a multiplex remote control mode execution-impossible message is received from the second device 860, the first device 830 outputs the multiplex remote control mode execution-impossible message in step 1017. In step 1019, the first device 830 sends the multiplex remote control mode execution-impossible message to the portable terminal 800.

If a multiplex remote control mode execution response message is from the second device 860 in step 1015, the first device 830 performs an authentication operation on the portable terminal 800 according to a predetermined authentication method using the AK included in the multiplex remote control mode execution request message in step 1021. The authentication method may be realized in various different ways, and a detailed description thereof will be omitted.

In step 1023, the first device 830 checks if the authentication on the portable terminal 800 is successful. Upon failure in the authentication on the portable terminal 800, the first device 830 outputs a multiplex remote control mode execution-impossible message indicating the impossibility of executing the multiplex remote control mode using the portable terminal 800 in step 1025. In step 1027, the first device 830 sends the multiplex remote control mode execution-impossible message to the portable terminal 800. On the other hand, upon success in the authentication on the portable terminal 800 in step 1023, the first device 830 sends a multiplex remote control mode execution response message indicating the possibility of executing the multiplex remote control mode and being responsive to the multiplex remote control mode execution request message, to the portable terminal 800 in step 1029.

In step 1031, the first device 830 receives a multiplex remote control mode execution confirm message from the portable terminal 800. In step 1033, the first device 830 sends the multiplex remote control mode execution confirm message to the second device 860. In step 1035, the first device 830 switches its operation mode to the multiplex remote control mode.

In step 1037, the first device 830 detects occurrence of first-device data to output. In step 1039, the first device 830 sends a first-device data message including first-device data to the portable terminal 800. In step 1041, the first device 830 outputs the detected first-device data.

In step 1043, the first device 830 receives an even data message including event data from the second device 860. For example, the event data may be generated when a Bell button on the second device 860 is pushed. In step 1045, the first device 830 sends the event data message received from the second device 860, to the portable terminal 800. In step 1047, the first device 830 detects and outputs the event data included in the event data message. Upon receiving a remote control message including a remote control command to remotely control the second device 860, from the portable terminal 800 in step 1049 after outputting the event data, the first device 830 sends the remote control message received from the portable terminal 800 to the second device 860 in step 1051. In step 1053, the first device 830 detects and outputs the remote control command included in the remote control message. In step 1055, the first device 830 receives a remote control command execution result message including the result of executing an operation corresponding to the remote control command, i.e., including the remote control command execution result, from the second device 860. In step 1057, the first device 830 sends the remote control command execution result message received from the second device 860, to the portable terminal 800. In step 1059, the first device 830 detects and outputs the remote control command execution result included in the remote control command execution result message.

It is assumed in FIGS. 10A and 10B that in FIGS. 8A to 8C, after the portable terminal 800 sent a multiplex remote control mode execution request message, the first device 830 performs an authentication operation on the portable terminal 800 in response to the request. Therefore, if the portable terminal 800, the first device 830, and the second device 860 perform an authentication operation in advance in FIGS. 8A to 8C, the operation process of the first device 830 in FIGS. 10A and 10B may be modified according thereto.

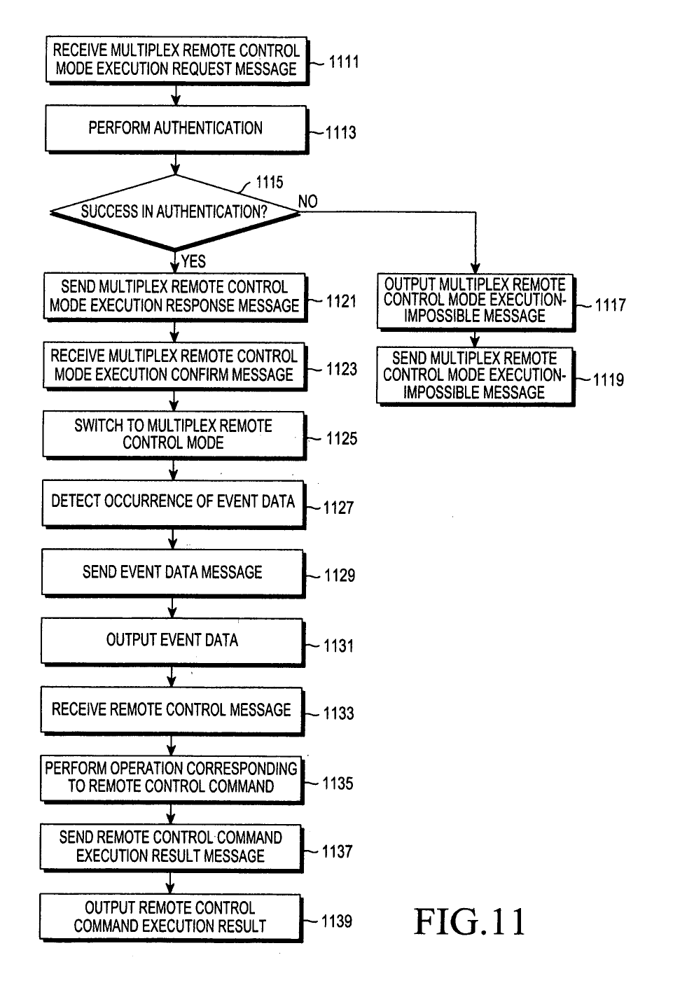

The operation process of the first device 830 in FIGS. 8A to 8C has been described with reference to FIGS. 10A and 10B. An operation process of the second device 860 in FIGS. 8A to 8C will now be described with reference to FIG. 11.

FIG. 11 illustrates an operation process of the second device 860 in FIGS. 8A to 8C.

Referring to FIG. 11, upon receiving a multiplex remote control mode execution request message from the first device 830 in step 1111, the second device 860 performs an authentication operation on the portable terminal 800 and the first device 830 according to a predetermined authentication method using the AK included in the multiplex remote control mode execution request message in step 1113. The authentication method may be realized in various different ways, and a detailed description thereof will be omitted.

In step 1115, the second device 860 checks if the authentication on the portable terminal 800 and the first device 830 is successful. Upon failure in the authentication on the portable terminal 800 and the first device 830, the second device 860 outputs a multiplex remote control mode execution-impossible message indicating the impossibility of executing the multiplex remote control mode using the portable terminal 800 in step 1117, and sends the multiplex remote control mode execution-impossible message to the first device 830 in step 1119. On the other hand, upon success in the authentication on the portable terminal 800 and the first device 830, the second device 860 sends a multiplex remote control mode execution response message indicating the possibility of executing the multiplex remote control mode to the first device 830 in step 1121. Upon receiving a multiplex remote control mode execution confirm message from the first device 830 in step 1123, the second device 860 switches its operation mode to the multiplex remote control mode in step 1125.

Upon detecting occurrence of event data for remote control in step 1127, the second device 860 sends an event data message including the event data to the first device 830 in step 1129, and outputs the event data in step 1131. Upon receiving a remote control message from the first device 830 in step 1133, the second device 860 performs an operation corresponding to a remote control command included in the remote control command in step 1135. In step 1137, the second device 860 sends a remote control command execution result message including the result of executing the operation corresponding to the remote control command, i.e., including the remote control command execution result, to the first device 830. In step 1139, the second device 860 outputs the remote control command execution result.

It is assumed in FIG. 11 that in FIGS. 8A to 8C, after receiving a multiplex remote control mode execution response message from the second device 860, the first device 830 performs an authentication operation on the second device 860. Therefore, if the portable terminal 800, the first device 830, and the second device 860 perform an authentication operation in advance in FIGS. 8A to 8C, the operation process of the second device 860 in FIG. 11 may be modified according thereto.

As is apparent from the foregoing description, the device automation system according to exemplary embodiments of the present invention enables a user to remotely control devices using a touch interface of a portable terminal, thereby improving user convenience without incurring any additional costs. In other words, even though each of the devices constituting the device automation system does not have its own touch interface, the user may control the devices using a touch interface of the portable terminal, increasing user convenience without incurring any additional costs.

In addition, a plurality of devices constituting a device automation system according to the present invention may be mutually controlled using wireless interfaces mounted therein, thereby enabling a multiplex interface of the device automation system. In this case, a user may control devices constituting the device automation system using only a portable terminal, thereby increasing user convenience. In addition, because of the availability of the multiplex interface, even though only a specific one of the devices constituting the device automation system has a processor with a relatively high processing capability, all the devices may be efficiently controlled, making it possible to efficiently control the devices without any increase in the overall cost of the device automation system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a device by a portable terminal in a device automation system, comprising:
upon detecting an execution request for a single remote control mode for remotely controlling a device, sending a single remote control mode execution request message for requesting to execute the single remote control mode, to the device;
upon receiving from the device a single remote control mode execution response message being responsive to the single remote control mode execution request message, switching an operation mode thereof to the single remote control mode;
upon receiving from the device a device data message including device data output by the device, outputting the device data; and
upon detecting a remote control command to remotely control the device while outputting the device data, sending a remote control message including the remote control command to the device.

2. The method of claim 1, further comprising:
receiving from the device a remote control command execution result message including a remote control command execution result indicative of a result of executing an operation corresponding to the remote control command; and
outputting the remote control command execution result.

3. The method of claim 1, wherein the single remote control mode execution request message includes an Identifier (ID) of the portable terminal, an ID of the device, and an authentication key.

4. The method of claim 1, wherein the detecting an execution request for a single remote control mode comprises receiving a single remote control mode execution request message from the device.

5. The method of claim 1, further comprising:
upon receiving from the device a single remote control mode execution-impossible message indicating impossibility of controlling the device using the portable terminal, outputting the single remote control mode execution-impossible message.

6. A method for performing an operation by a device in a device automation system, comprising:
receiving from a portable terminal a single remote control mode execution request message for requesting to execute a single remote control mode for remotely controlling the device;
sending a single remote control mode execution response message being responsive to the single remote control mode execution request message, to the portable terminal, and then switching an operation mode thereof to the single remote control mode;
upon detecting device data to output, sending a device data message including the device data to the portable terminal; and
upon receiving a remote control message including a remote control command to remotely control the device from the portable terminal while outputting the device data, performing an operation corresponding to the remote control command.

7. The method of claim 6, further comprising:
sending to the portable terminal a remote control command execution result message including a remote control command execution result indicative of a result of executing an operation corresponding to the remote control command; and
outputting the remote control command execution result.

8. The method of claim 6, further comprising performing an authentication operation on the portable terminal before or after receiving the single remote control mode execution request message; and
wherein when the authentication operation is performed after receiving the single remote control mode execution request message, the performing an authentication operation comprises, upon failure in authentication on the portable terminal, sending to the portable terminal a single remote control mode execution-impossible message indicating impossibility of controlling the device using the portable terminal.

9. The method of claim 6, further comprising performing an authentication operation on the portable terminal before or after receiving the single remote control mode execution request message; and
wherein when the authentication operation is performed after receiving the single remote control mode execution request message, the performing an authentication operation comprises, upon failure in authentication on the portable terminal, outputting a single remote control mode execution-impossible message indicating impossibility of controlling the device using the portable terminal.

10. The method of claim 6, further comprising performing an authentication operation on the portable terminal before or after receiving the single remote control mode execution request message, wherein the single remote control mode execution request message includes an Identifier (ID) of the portable terminal, an ID of the device, and an authentication key; and
wherein when the authentication operation is performed after receiving the single remote control mode execution request message, the performing an authentication operation comprises authenticating the portable terminal according to a predetermined authentication method using the authentication key.

11. A method for controlling a device by a portable terminal in a device automation system, comprising:
upon detecting an execution request for a multiplex remote control mode for remotely controlling a first device and a second device, sending to the first device a multiplex remote control mode execution request message for requesting to execute the multiplex remote control mode;
upon receiving from the first device a multiplex remote control mode execution response message being responsive to the multiplex remote control mode execution request message, sending a multiplex remote control mode execution confirm message to the first device;
switching an operation mode thereof to the multiplex remote control mode after sending the multiplex remote control mode execution confirm message;
upon receiving from the first device a first-device data message including first-device data output by the first device, outputting the first-device data;
upon receiving an event data message including event data generated in the second device from the first device while outputting the first-device data, outputting the event data; and
upon detecting a remote control command to remotely control the second device after outputting the event data, sending a remote control message including the remote control command to the second device through the first device.

12. The method of claim 11, further comprising:
receiving from the first device a remote control command execution result message including a remote control command execution result indicative of a result of executing by the second device an operation corresponding to the remote control command; and
outputting the remote control command execution result.

13. The method of claim 11, wherein the multiplex remote control mode execution request message includes an Identifier (ID) of the portable terminal, an ID of the first device, an ID of the second device, and an authentication key.

14. The method of claim 11, wherein the detecting an execution request for a multiplex remote control mode comprises receiving a multiplex remote control mode execution request message from the first device.

15. The method of claim 11, further comprising:
upon receiving from the first device a multiplex remote control mode execution-impossible message indicating impossibility of controlling the first device and the second device using the portable terminal, outputting the multiplex remote control mode execution-impossible message.

16. A method for performing an operation by a first device in a device automation system, comprising:
receiving from a portable terminal a multiplex remote control mode execution request message for requesting to execute a multiplex remote control mode for remotely controlling the first device and a second device;
sending the multiplex remote control mode execution request message to the second device;
upon receiving a multiplex remote control mode execution response message from the second device, sending to the portable terminal the multiplex remote control mode execution response message being responsive to the multiplex remote control mode execution request message;
switching an operation mode thereof to the multiplex remote control mode after receiving a multiplex remote control mode execution confirm message from the portable terminal;
upon detecting first-device data to output, sending a first-device data message including the first-device data to the portable terminal;
upon receiving an event data message including event data generated in the second device from the second device while outputting the first-device data, sending the event data message to the portable terminal; and
upon receiving a remote control message including a remote control command to remotely control the second device from the portable terminal after outputting the event data, sending the remote control message to the second device.

17. The method of claim 16, further comprising:
receiving from the second device a remote control command execution result message including a remote control command execution result indicative of a result of executing by the second device an operation corresponding to the remote control command; and
sending the remote control command execution result message to the portable terminal, and then outputting the remote control command execution result.

18. The method of claim 16, further comprising:
upon receiving from the second device a multiplex remote control mode execution-impossible message indicating impossibility of remotely controlling the second device using the portable terminal, sending the multiplex remote control mode execution-impossible message to the portable terminal.

19. The method of claim 16, further comprising:
upon receiving from the second device a multiplex remote control mode execution-impossible message indicating impossibility of remotely controlling the second device using the portable terminal, outputting the multiplex remote control mode execution-impossible message.

20. The method of claim 16, further comprising performing an authentication operation on the portable terminal before or after receiving the multiplex remote control mode execution request message; and
wherein when the authentication operation is performed after receiving the multiplex remote control mode execution request message, the performing an authentication operation comprises, upon failure in authentication on the portable terminal, sending to the portable terminal a multiplex remote control mode execution-impossible message indicating impossibility of controlling the first device and the second device using the portable terminal.

21. The method of claim 16, further comprising performing an authentication operation on the portable terminal before or after receiving the multiplex remote control mode execution request message; and
wherein when the authentication operation is performed after receiving the multiplex remote control mode execution request message, the performing an authentication operation comprises, upon failure in authentication on the portable terminal, outputting a multiplex remote control mode execution-impossible message indicating impossibility of controlling the first device and the second device using the portable terminal.

22. The method of claim 16, further comprising performing an authentication operation on the portable terminal before or after receiving the multiplex remote control mode execution request message, wherein the multiplex remote control mode execution request message includes an Identifier (ID) of the portable terminal, an ID of the first device, an ID of the second device, and an authentication key; and
wherein when the authentication operation is performed after receiving the multiplex remote control mode execution request message, the performing an authentication operation comprises authenticating the portable terminal according to a predetermined authentication method using the authentication key.

23. A method for performing an operation by a second device in a device automation system, comprising:
receiving from the first device a multiplex remote control mode execution request message for requesting to execute a multiplex remote control mode for remotely controlling a first device and the second device using a portable terminal;
sending to the first device a multiplex remote control mode execution response message being responsive to the multiplex remote control mode execution request message;
switching an operation mode thereof to the multiplex remote control mode after receiving a multiplex remote control mode execution confirm message from the first device;
upon detecting occurrence of event data, sending an event data message including the event data to the first device; and
upon receiving a remote control message including a remote control command to remotely control the second device from the first device while outputting the event data, performing an operation corresponding to the remote control command.

24. The method of claim 23, further comprising:
sending to the first device a remote control command execution result message including a remote control command execution result indicative of a result of executing an operation corresponding to the remote control command; and
outputting the remote control command execution result.

25. The method of claim 24, further comprising performing an authentication operation on the portable terminal and the first device before or after receiving the multiplex remote control mode execution request message; and
wherein when the authentication operation is performed after receiving the multiplex remote control mode execution request message, the performing an authentication operation comprises, upon failure in authentication on the portable terminal and the first device, sending to the first device a multiplex remote control mode execution-impossible message indicating impossibility of controlling the first device and the second device using the portable terminal.

26. The method of claim 24, further comprising performing an authentication operation on the portable terminal and the first device before or after receiving the multiplex remote control mode execution request message; and
wherein when the authentication operation is performed after receiving the multiplex remote control mode execution request message, the performing an authentication operation comprises, upon failure in authentication on the portable terminal and the first device, outputting a multiplex remote control mode execution-impossible message indicating impossibility of controlling the first device and the second device using the portable terminal.

27. The method of claim 24, further comprising performing an authentication operation on the portable terminal and the first device before or after receiving the multiplex remote control mode execution request message, wherein the multiplex remote control mode execution request message includes an Identifier (ID) of the portable terminal, an ID of the first device, an ID of the second device, and an authentication key; and
wherein when the authentication operation is performed after receiving the multiplex remote control mode execution request message, the performing an authentication operation comprises authenticating the portable terminal and the first device according to a predetermined authentication method using the authentication key.

28. A portable terminal in a device automation system, comprising:
a control unit;
a wireless interface unit; and
an output unit;
wherein if the control unit detects an execution request for a single remote control mode for remotely controlling a device, the wireless interface unit sends a single remote control mode execution request message for requesting to execute the single remote control mode, to the device;
wherein if the wireless interface unit receives from the device a single remote control mode execution response message being responsive to the single remote control mode execution request message, the control unit switches an operation mode thereof to the single remote control mode;
wherein if the wireless interface unit receives from the device a device data message including device data output by the device, the output unit outputs the device data; and
wherein if the control unit detects a remote control command to remotely control the device while the output unit outputs the device data, the wireless interface unit sends a remote control message including the remote control command to the device.

29. The portable terminal of claim 28, wherein the wireless interface unit receives from the device a remote control command execution result message including a remote control command execution result indicative of a result of executing an operation corresponding to the remote control command; and
wherein the output unit outputs the remote control command execution result.

30. The portable terminal of claim 28, wherein the single remote control mode execution request message includes an Identifier (ID) of the portable terminal, an ID of the device, and an authentication key.

31. The portable terminal of claim 28, wherein the wireless interface unit receives a single remote control mode execution request message from the device.

32. The portable terminal of claim 28, wherein if the wireless interface unit receives from the device a single remote control mode execution-impossible message indicating impossibility of controlling the device using the portable terminal, the output unit outputs the single remote control mode execution-impossible message.

33. A device in a device automation system, comprising:
a control unit;
a wireless interface unit; and
an output unit;
wherein the wireless interface unit receives from a portable terminal a single remote control mode execution request message for requesting to execute a single remote control mode for remotely controlling the device, and sends a single remote control mode execution response message being responsive to the single remote control mode execution request message, to the portable terminal;
wherein the control unit switches an operation mode of the device to the single remote control mode;
wherein if the control unit detects device data to output, the wireless interface unit sends a device data message including the device data to the portable terminal; and
wherein if the wireless interface unit receives a remote control message including a remote control command to remotely control the device from the portable terminal while the output unit outputs the device data, the control unit performs an operation corresponding to the remote control command.

34. The device of claim 33, wherein the wireless interface unit sends to the portable terminal a remote control command execution result message including a remote control command execution result indicative of a result of executing an operation corresponding to the remote control command; and
wherein the output unit outputs the remote control command execution result.

35. The device of claim 33, wherein the control unit performs an authentication operation on the portable terminal before or after the single remote control mode execution request message is received; and
wherein when performing the authentication operation after the single remote control mode execution request message is received, if the control unit fails in authentication on the portable terminal, the wireless interface unit sends to the portable terminal a single remote control mode execution-impossible message indicating impossibility of controlling the device using the portable terminal.

36. The device of claim 33, wherein the control unit performs an authentication operation on the portable terminal before or after the single remote control mode execution request message is received; and
wherein when performing the authentication operation after the single remote control mode execution request message is received, if the control unit fails in authentication on the portable terminal, the output unit outputs a single remote control mode execution-impossible message indicating impossibility of controlling the device using the portable terminal.

37. The device of claim 33, wherein the control unit performs an authentication operation on the portable terminal before or after the single remote control mode execution request message is received, wherein the single remote control mode execution request message includes an Identifier (ID) of the portable terminal, an ID of the device, and an authentication key; and
wherein when performing the authentication operation after the single remote control mode execution request message is received, the control unit authenticates the portable terminal according to a predetermined authentication method using the authentication key.

38. A portable terminal in a device automation system, comprising:
a control unit;
a wireless interface unit; and
an output unit;
wherein if the control unit detects an execution request for a multiplex remote control mode for remotely controlling a first device and a second device, the wireless interface unit sends to the first device a multiplex remote control mode execution request message for requesting to execute the multiplex remote control mode;
wherein upon receiving from the first device a multiplex remote control mode execution response message being responsive to the multiplex remote control mode execution request message, the wireless interface unit sends a multiplex remote control mode execution confirm message to the first device;
wherein the control unit switches an operation mode of the portable terminal to the multiplex remote control mode after the wireless interface unit sends the multiplex remote control mode execution confirm message;
wherein if the wireless interface unit receives from the first device a first-device data message including first-device data output by the first device, the output unit outputs the first-device data;
wherein if the wireless interface unit receives an event data message including event data generated in the second device from the first device while the output unit outputs the first-device data, the output unit outputs the event data; and
wherein if the control unit detects a remote control command to remotely control the second device after the output unit outputs the event data, the wireless interface unit sends a remote control message including the remote control command to the second device through the first device.

39. The portable terminal of claim 38, wherein the wireless interface unit receives from the first device a remote control command execution result message including a remote control command execution result indicative of a result of executing by the second device an operation corresponding to the remote control command; and
wherein the output unit outputs the remote control command execution result.

40. The portable terminal of claim 38, wherein the multiplex remote control mode execution request message includes an Identifier (ID) of the portable terminal, an ID of the first device, an ID of the second device, and an authentication key.

41. The portable terminal of claim 38, wherein the wireless interface unit receives a multiplex remote control mode execution request message from the first device.

42. The portable terminal of claim 38, wherein if the wireless interface unit receives from the first device a multiplex remote control mode execution-impossible message indicating impossibility of controlling the first device and the second device using the portable terminal, the output unit outputs the multiplex remote control mode execution-impossible message.

43. A first device in a device automation system, comprising:
a control unit;
a wireless interface unit; and
an output unit;
wherein the wireless interface unit receives from a portable terminal a multiplex remote control mode execution request message for requesting to execute a multiplex remote control mode for remotely controlling the first device and a second device, sends the multiplex remote control mode execution request message to the second device, and upon receiving a multiplex remote control mode execution response message from the second device, sends to the portable terminal the multiplex remote control mode execution response message being responsive to the multiplex remote control mode execution request message;
wherein the control unit switches an operation mode of the first device to the multiplex remote control mode after the wireless interface unit receives a multiplex remote control mode execution confirm message from the portable terminal;
wherein if the control unit detects first-device data to output, the wireless interface unit sends a first-device data message including the first-device data to the portable terminal;
wherein if the wireless interface unit receives an event data message including event data generated in the second device from the second device while the output unit outputs the first-device data, the wireless interface unit sends the event data message to the portable terminal; and
wherein if the wireless interface unit receives a remote control message including a remote control command to remotely control the second device from the portable terminal after the output unit outputs the event data, the wireless interface unit sends the remote control message to the second device.

44. The first device of claim 43, wherein the wireless interface unit receives from the second device a remote control command execution result message including a remote control command execution result indicative of a result of executing by the second device an operation corresponding to the remote control command; and
wherein after the wireless interface unit sends the remote control command execution result message to the portable terminal, the output unit outputs the remote control command execution result.

45. The first device of claim 43, wherein if the wireless interface unit receives from the second device a multiplex remote control mode execution-impossible message indicating impossibility of remotely controlling the second device using the portable terminal, the wireless interface unit sends the multiplex remote control mode execution-impossible message to the portable terminal.

46. The first device of claim 43, wherein if the wireless interface unit receives from the second device a multiplex remote control mode execution-impossible message indicating impossibility of remotely controlling the second device using the portable terminal, the output unit outputs the multiplex remote control mode execution-impossible message.

47. The first device of claim 43, wherein the control unit performs an authentication operation on the portable terminal before or after the multiplex remote control mode execution request message is received; and
wherein when performing the authentication operation after the multiplex remote control mode execution request message is received, if the control unit fails in authentication on the portable terminal, the wireless interface unit sends to the portable terminal a multiplex remote control mode execution-impossible message indicating impossibility of controlling the first device and the second device using the portable terminal.

48. The first device of claim 43, wherein the control unit performs an authentication operation on the portable terminal before or after the multiplex remote control mode execution request message is received; and
wherein when performing the authentication operation after the multiplex remote control mode execution request message is received, if the control unit fails in authentication on the portable terminal, the output unit outputs a multiplex remote control mode execution-impossible message indicating impossibility of controlling the first device and the second device using the portable terminal.

49. The first device of claim 43, wherein the control unit performs an authentication operation on the portable terminal before or after the multiplex remote control mode execution request message is received, wherein the multiplex remote control mode execution request message includes an Identifier (ID) of the portable terminal, an ID of the first device, an ID of the second device, and an authentication key; and
wherein when performing the authentication operation after the multiplex remote control mode execution request message is received, the control unit authenticates the portable terminal according to a predetermined authentication method using the authentication key.

50. A second device in a device automation system, comprising:
a control unit;
a wireless interface unit; and
an output unit;
wherein the wireless interface unit receives from the first device a multiplex remote control mode execution request message for requesting to execute a multiplex remote control mode for remotely controlling a first device and the second device using a portable terminal, and sends to the first device a multiplex remote control mode execution response message being responsive to the multiplex remote control mode execution request message;
wherein the control unit switches an operation mode of the second device to the multiplex remote control mode after the wireless interface unit receives a multiplex remote control mode execution confirm message from the first device;
wherein if the control unit detects occurrence of event data, the wireless interface unit sends an event data message including the event data to the first device; and
wherein if the wireless interface unit receives a remote control message including a remote control command to remotely control the second device from the first device while the output unit outputs the event data, the control unit performs an operation corresponding to the remote control command.

51. The second device of claim 50, wherein the wireless interface unit sends to the first device a remote control command execution result message including a remote control command execution result indicative of a result of executing an operation corresponding to the remote control command; and
wherein the output unit outputs the remote control command execution result.

52. The second device of claim 51, wherein the control unit performs an authentication operation on the portable terminal and the first device before or after the multiplex remote control mode execution request message is received; and
wherein when performing the authentication operation after the multiplex remote control mode execution request message is received, if the control unit fails in authentication on the portable terminal and the first device, the wireless interface unit sends to the first device a multiplex remote control mode execution-impossible message indicating impossibility of controlling the first device and the second device using the portable terminal.

53. The second device of claim 51, wherein the control unit performs an authentication operation on the portable terminal and the first device before or after the multiplex remote control mode execution request message is received; and
wherein when performing the authentication operation after the multiplex remote control mode execution request message is received, if the control unit fails in authentication on the portable terminal and the first device, the output unit outputs a multiplex remote control mode execution-impossible message indicating impossibility of controlling the first device and the second device using the portable terminal.

54. The second device of claim 51, wherein the control unit performs an authentication operation on the portable terminal and the first device before or after the multiplex remote control mode execution request message is received, wherein the multiplex remote control mode execution request message includes an Identifier (ID) of the portable terminal, an ID of the first device, an ID of the second device, and an authentication key; and
wherein when performing the authentication operation after the multiplex remote control mode execution request message is received, the control unit authenticates the portable terminal and the first device according to a predetermined authentication method using the authentication key.
